(19) United States
(12) Patent Application Publication
(10) Pub. No.: US 2007/0052549 A1
(43) Pub. Date: Mar. 8, 2007

(54) Apparatus and method for updating encoded signal information stored in a remote control unit through direct key entry

(75) Inventor: Rong Le, Schenectady, NY (US)

Correspondence Address: FRISHAUF, HOLTZ, GOODMAN & CHICK, PC, 220 Fifth Avenue, 16TH Floor, NEW YORK, NY, 10001-7708, US

(73) Assignee: CONTEC CORPORATION, Schenectady, NY (US)

(21) Appl. No.: 11/209,279

(22) Filed: Aug. 22, 2005

(51) Int. Cl. G08C 19/00

(52) U.S. Cl. 340/825.72

(57) ABSTRACT

A method for updating a memory of a universal remote control unit includes the steps of initiating, by a user, an upgrading mode; entering, by a user, a code associated with a device to be controlled by the remote control unit; entering, by a user, a signal formatting data entry which includes signal formatting data, via the keys of the keypad, to be stored in the memory of the remote control unit; and associating the device to be controlled by the remote control unit with the signal formatting data entry such that when one or more of a device type key associated with a device type is subsequently depressed, subsequent commands sent by the remote control unit have the format specified by the signal formatting data, and when a command key uniquely associated with the device type is depressed, commands sent by the remote control unit have the format specified by the signal formatting data.

### FIELD OF THE INVENTION

The present invention relates generally to remote control units in which encoded signal formatting information is stored therein and accessed to generate control signals for remotely controlling a plurality of electronic devices, and to a method of updating a remote control unit to store new signal encoded formatting information that was not previously contained in the memory of the remote control unit.

### BACKGROUND OF THE INVENTION

Remote control units have gained widespread popularity for use in remotely controlling electronic devices such as televisions, cable set-top boxes or converters, videocassette recorders (VCR), digital video disc (DVD) players/recorders and stereos. Typically each electronic device includes a separate remote control unit provided by the manufacturer, to remotely control the specific device. This causes a user with multiple electronic devices to have numerous remote control units, which is very cumbersome and leads to confusion for the user.

In order to eliminate the need for multiple remote control units, universal remote control units have been developed. A universal remote control unit has a plurality of operating modes for controlling a plurality of electronic devices. Each operating mode enables the user to remotely control a corresponding device. Typically, the universal remote control unit includes a plurality of mode push buttons (e.g., CABLE, TV, VCR, DVD and AUDIO push buttons) which correspond to the different devices to be controlled. The mode push buttons are used to directly change the operating mode of a corresponding device. In order for the universal remote control unit to operate each of the different devices, the remote control unit must be programmed to send a signal which is recognized only by the selected device, to obtain an appropriate response from the device.

Typically, universal remote control units include a memory which stores a plurality of encoded signal formatting information which correspond to signal structures to which specific manufacturer and model number devices are responsive. The signal formatting information commonly varies based on the device to be controlled. Programming the universal remote control unit involves identifying the signal formatting information which generates a signal to which the device to be controlled is responsive.

With the development of new models of televisions, cable set-top boxes or converters, videocassette recorders, digital video disc players/recorders and stereos, manufacturers sometimes employ new signals and/or signal formats to remotely control the new electronic devices. The new signals and/or signal formats are typically not known to the universal remote control unit manufacturer prior to the public release of a new electronic device. As a result, the universal remote control devices manufactured before a new model electronic device (for example, a television) is publicly available may not include the signal formatting information necessary to generate the control signals to remotely control the new model electronic device. More specifically, the signal formatting information which is utilized to generate the control signals for remotely controlling some new electronic devices may not be stored in the memory of a universal remote control unit which was manufactured before the particular model of electronic device was made available to consumers. Therefore, in order to remotely control such a new electronic device with a previously purchased universal remote control unit, the memory of the remote control unit must be updated to include the signal formatting information which will generate the control signal to which the new electronic device is responsive.

Methods for updating the memory of universal remote control units to include new signal formatting data have been employed. A first method includes dispatching a technician to the user's home to capture the control signals from the remote control unit provided with the new electronic product and downloading the captured signals to the memory of the universal remote controller via a serial or USB port.

Alternative methods include electronically coupling the universal remote control unit to a user's computer and downloading the appropriate signal formatting information to the memory of the remote control unit from a manufacturer, or inserting an additional memory chip which includes the new signal formatting information into the remote control unit.

A further method for use with universal remote control units that include a signal receiver involves directing generated control signals of the remote control unit of the new electronic device at the receiver of the universal remote control unit to capture and store the control signal of the new electronic device.

The known updating methods are for use with universal remote control units which include a serial port, a USB port, a receiver to capture the new control signals or a slot to receive an additional memory chip. However, if the universal remote control unit does not include these features, the prior art methods do not teach how the universal remote control unit could be updated by a user.

### SUMMARY OF THE INVENTION

Therefore, there is a need for a universal remote control unit whose memory can be updated to include new signal formatting data to generate control signals to remotely control an electronic device whose signal formatting information was not previously stored in the memory of the universal remote control device, and a method for achieving the same.

In accordance with one form of the present invention, a universal remote control unit for remotely controlling a plurality of devices, which can be updated with new signal formatting data includes a memory having a plurality of locations for storing signal formatting entries at respective locations in the memory which are permanently written therein, and a location for storing a signal formatting entry which can be rewritten; a keypad having a plurality of keys for entering, by a user, a first sequence of keypad strokes for actuating an upgrade mode and entering, by a user, a second sequence of keypad strokes indicative of new signal formatting data not previously stored in the memory; a transmitter; a processor which, when an upgrade mode is actuated by the user entering the first sequence of keypad strokes, enables the user to enter the second sequence of keypad strokes indicative of the new signal formatting data not previously stored in the memory, and stores the new signal formatting data in one of the plurality of memory locations for storing signal formatting data not previously stored in the memory.

In accordance with another form of the present invention, a method for upgrading a universal remote control unit which includes a keypad having keys with new signal formatting data includes the steps of initiating, by a user, an upgrading mode; entering, by a user, a code associated with a device type to be controlled by the remote control unit; entering, by a user, a signal formatting data entry which includes signal formatting data, via the keys of the keypad, to be stored in the memory of the remote control unit; and associating the device type to be controlled by the remote control unit with the signal formatting data entry.

In accordance with yet another form of the present invention, an article of manufacture includes a computer usable medium having computer readable program code means embodied therein for updating a memory of a universal remote control unit which includes a keypad having keys, the computer readable program code means in said article of manufacture including a computer usable medium having computer readable program code means embodied therein for initiating, by a user, an updating mode; a computer usable medium having computer readable program code means embodied therein for entering, by a user, a code associated with a device type to be controlled by the remote control unit; a computer usable medium having computer readable program code means embodied therein for entering, by a user, a signal formatting data entry which includes signal formatting data, via the keys of the keypad, to be stored in the memory of the remote control unit; and a computer usable medium having computer readable program code means embodied therein for associating the device type to be controlled by the remote control unit with the signal formatting data entry.

The above and other objects, features and advantages of the present invention will become readily apparent from the following detailed description thereof, which is to be read in connection with the accompanying drawings.

### BRIEF DESCRIPTION OF THE DRAWINGS

FIG. 1 is a front plan view of one embodiment of a universal remote control unit according to the present invention capable of being updated with new signal formatting data;

FIG. 2 is a block diagram of the universal remote control unit shown in FIG. 1;

FIG. 3 is a diagram showing the contents of one signal formatting data entry for controlling a television stored in the memory of the remote control unit;

FIG. 4 is a diagram showing an alternative embodiment of the contents of one signal formatting data entry for controlling a television stored in the memory of the remote control unit; and

FIG. 5 is a flow chart of the method for updating the universal remote control unit shown in FIG. 1, via a keypad, with new signal formatting data;

FIG. 6 is a chart showing the update of the memory of the universal remote control unit at Steps 112, 128, 132 and 134 of FIG. 5; and

FIG. 7 is a flow chart of how the update code which has been stored in the method shown in FIG. 5 is used for signal generation.

### DETAILED DESCRIPTION OF THE PREFERRED EMBODIMENTS

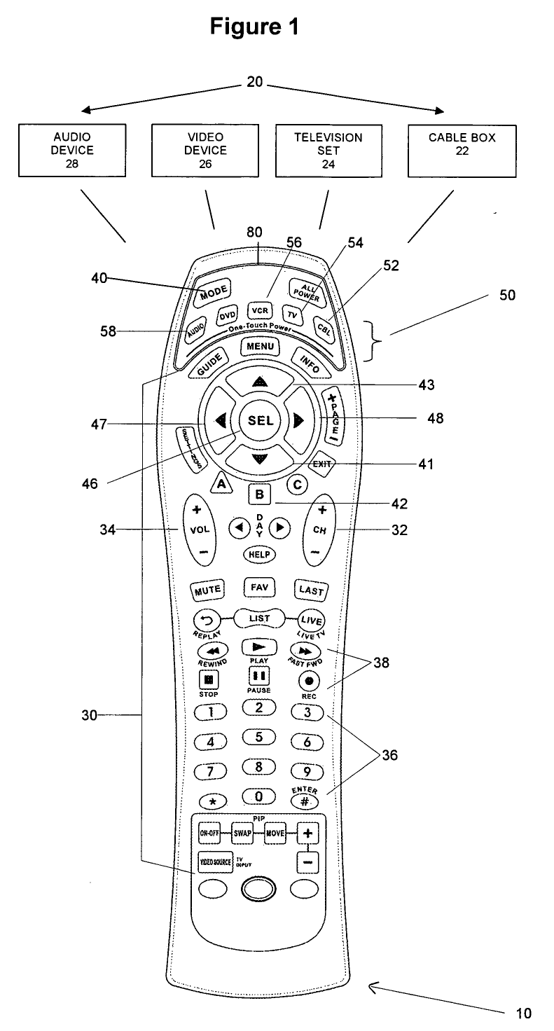

Referring initially to FIG. 1 of the drawings, an exemplary universal remote control unit 10 of the present invention for controlling a plurality of electronic devices 20 is shown. As will be explained in greater detail below, universal remote control unit 10 is configured to enter an update mode. The update mode enables a user to input and store new signal formatting data of an electronic device that is non-responsive to the control signals generated by the signal formatting data which are already stored in the memory of the remote control unit.

Examples of the plurality of devices 20 which may be controlled by the universal remote control unit 10 include a cable set-top box or a converter 22, a television set 24, a video device 26 such as a videocassette recorder, a digital video disc (DVD) player (not shown), or a personal video recorder (PVR) (not shown), and an audio device 28 such as an amplifier, surround sound audio system, a digital music converter, or an audio-video receiver. This list is not meant to be limiting of the types of electronic devices which can be controlled by the universal remote control unit.

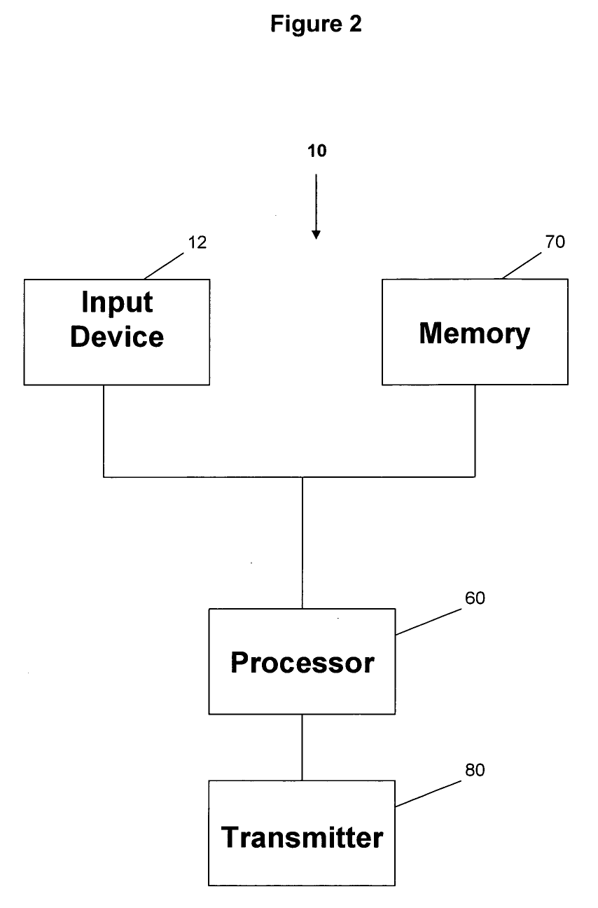

Universal remote control unit 10 includes an input device 12 (FIG. 2) which preferably consists of keyboard 30 for enabling a user to select a plurality of functions in connection with the operation of the plurality of electronic devices 20. As best shown in FIG. 1, keyboard 30 may include a CHANNEL push button 32, a VOLUME push button 34, a plurality of numbered (digit) push buttons 36, and a plurality of video function push buttons 38.

In addition, input device 12 (FIG. 2) also preferably includes a MODE push button 40 for initiating a mode change for changing the device (cable set-top box 22, television 24, video device 26 or audio device 28) controlled by the universal control unit 10, and a plurality of mode push buttons 50 such as a CABLE push button 52, a TV push button 54, a VIDEO push button 56, and an AUDIO push button 58 for placing universal remote control unit 10 in a respective one of a plurality of operating modes. For example, universal remote control unit 10 in its cable mode operates the functions of the cable box 22. In its television mode, universal remote control unit 10 operates the functions of television set 24. Desirably, each of the plurality of mode push buttons is illuminable having, for example, a backlit light-emitting diode.

With reference to FIG. 2, universal remote control unit 10 further includes a processor 60, a memory 70 for storing, among other things, a plurality of operating modes, and a transmitter 80. During operation of the universal remote control unit, activation of one of the plurality of push buttons of keyboard 30 (FIG. 1) by a user generates a command signal when depressed. This command signal is supplied to processor 60. In response thereto and as known in the art, processor 60 retrieves appropriate signal formatting data from memory 70. Processor 60 then causes transmitter 80 to generate and transmit signal pulses (a control signal) in accordance with the signal formatting data retrieved from memory, thereby causing one of the controlled devices, e.g., cable box 22, television 24, video device 26, or audio device 28, to carry out the command function.

Preferably, processor 60 is a programmable infrared (IR) low-voltage micro controller device such as Part No. GMS344XXXT from LG (Goldstar) Semicon Co., Ltd. of Korea. The processor is run by application software or programming (e.g., assembly language) and is typically governed by the manufacturer's protocol. The processor can be a single package design or multiple package design with external or additional memory storage, or any other suitable configuration.

The invention is not limited to such a processing environment, however. The present invention can be incorporated and used within many types of processing environments. From the following description, computer readable program code means for use in processor 60 and for implementing the present invention may be readily programmed by those skilled in the art and stored in memory 70 such as a memory chip or an integrated circuit.

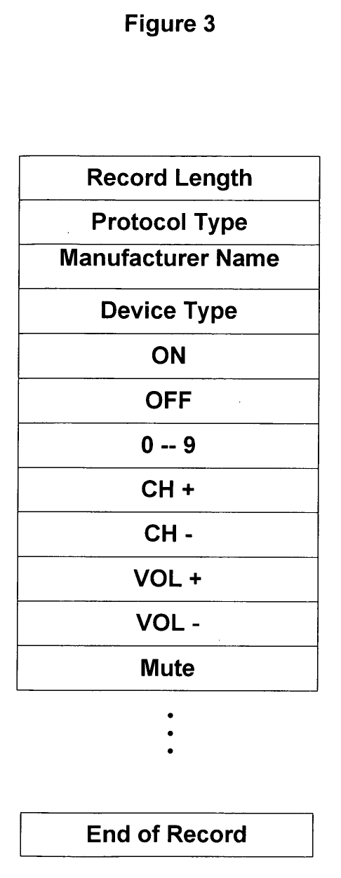

Referring to FIG. 3, an exemplary signal formatting data entry (or record) for controlling a television set 24 is shown. The signal formatting data entry includes a number of segments, some of which are informational (e.g., record length, manufacturer name, and device type), and others of which identify the signal configuration which is necessary to obtain a desired response from the television. The signal configuration portions of the signal formatting data include the protocol type, power on, power off, channel entry, channel up, channel down, volume up, volume down, and mute, among others. The signal formatting data need not be stored in the memory in a particular order. That is, the entries need not be stored in groups by manufacturer, category of device, or year of manufacture. Other signal formatting data entries will include signal configuration portions which are specific to the type of device. For example, a signal formatting data entry for a VCR will include, in addition to power on and power off, signal configurations for play, stop, pause, rewind, fast forward, etc.

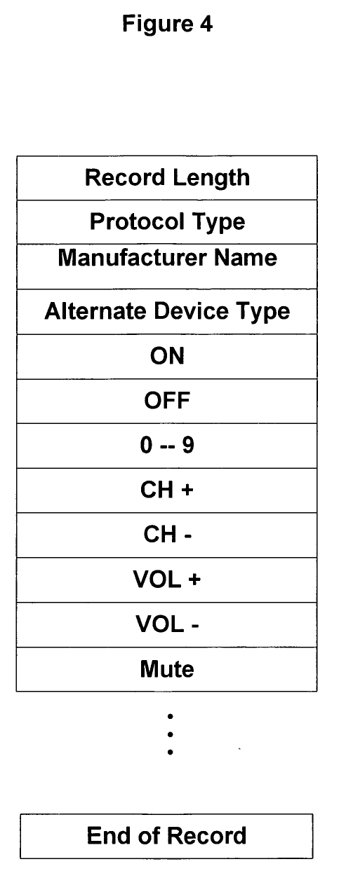

In another exemplary signal formatting data entry as shown in FIG. 4, the record for each signal formatting data stored in the universal remote control unit includes not only a manufacturer and device type which is the primary mode key with which the device is to be associated, but also an alternative device type which indicates a secondary mode key if the primary device type already has a device associated therewith.

During traditional programming (i.e., set up) of the universal remote control unit 10, the user identifies the manufacturer of each device to be controlled by the remote control unit, and locates the numerical number assigned to that device from a manufacturer and device type list in the universal remote control unit user manual. Thereafter through a series of button presses the user will enter a programming mode of the remote control unit. The user then inputs the corresponding numbers assigned to the name of the manufacturer and device type (for example, the three digit number 100 for a Sony TV) from the user manual. Once the number has been successfully entered, a confirmation LED blink will follow to indicate successful programming of the universal remote controller. If it is determined that the numerical code entered by the user is a valid code and operates the device to be controlled, the corresponding ROM address is stored in the RAM (random access memory) portion of the memory. If the first numerical code entered by the user is not a valid code or does not operate the device to be controlled, the user enters another numerical code from the manufacturer and device type list. This process is repeated until a code is identified which operates the device to be controlled.

If, however, the user cannot identify a code from the user manual which operates an electronic device, and the user is desirous of using the remote control unit to control the electronic device, the remote control unit must be updated to include corresponding signal formatting data in the remote control unit's memory to generate an appropriate control signal.

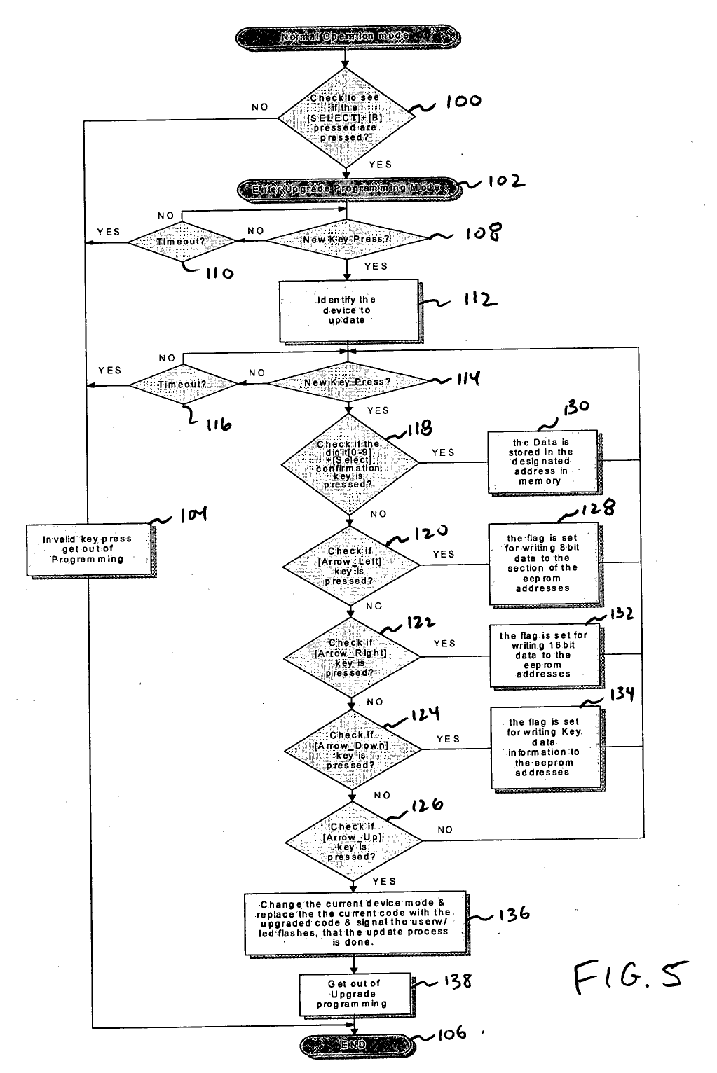

Referring now to FIG. 5, a method of updating the universal remote control unit (update mode) to store new signal formatting data is shown.

In order to enter the update programming mode, the remote control unit continuously monitors the keyboard input to determine whether a specific key press sequence occurs (Step 100). In the preferred embodiment the update mode is entered by pressing the SELECT key 46 and then the B key 42. If the correct sequence of keys is pressed (SELECT key and then B key) (YES in Step 100), then the universal remote control device enters the update programming mode (Step 102). However, if the sequence of key presses does not correspond to entering the update programming mode (that is, the SELECT key and B key are not pressed)(NO in Step 100), then a determination is made that an invalid key press has been made (Step 104), the upgrade programming mode is not entered, and the remote control unit returns to normal operation (Step 106).

If the update programming mode is entered (YES in Step 102) due to a correct sequence of key presses, a determination is made in Step 108 as to whether subsequent key presses are valid key presses and that the key presses occur within a specific period of time (Step 110) upon entering the upgrade programming mode (for example, within 10 seconds). Specifically the method is looking for an identification as to the type of device whose signal formatting data is to be updated. In the preferred embodiment, a determination is made as to whether a valid key entry (digit key 0-9) is made (Step 108). If a valid key entry has not been made (NO in Step 108), a determination is made as to whether the predetermined time period has elapsed since entering the programming mode. If the predetermined time period has elapsed since entering the programming mode (YES in Step 110), then it is determined that a valid key press has not been made (Step 104), the upgrade programming mode is exited, and the remote control unit returns to normal operation (Step 106).

If it is determined in Step 110 that the predetermined time period has not elapsed since entering the programming mode (NO in Step 110), then the method returns to Step 108 and monitors for a new key press entry.

If a valid key entry (digit key) is made (YES in Step 108), the key presses entered in Step 108 are analyzed to identify which electronic device will have updated signal formatting data associated therewith (Step 112). In the preferred embodiment, one additional CABLE code, two additional TELEVISION codes, one additional VCR code, two additional DVD codes, one additional CD code and one additional digital video recorder (DVR) code can be added to the memory. In the preferred embodiment, if it is determined in Step 112 that the user depressed the “0” and “1” keys, this is indicative of adding new signal formatting data to the memory to control the cable set-top box. Likewise, if it is determined in Step 112 that the “0” and “2” keys or “0” and “3” keys have been depressed, this is indicative of adding new signal formatting data to the memory to generate a new control code for a television. If it is determined in Step 112 that the “0” and “4” keys have been depressed, the VCR signal formatting data in the memory will be updated. If it is determined in Step 112 that the “0” and “5” keys or “0” and “6” keys have been depressed, this is indicative of updating the signal formatting data in the memory for the DVD player. If it is determined in Step 112 that the “0” and “7” keys have been depressed, this is indicative of updating the signal formatting data in the memory for the CD player, and if it is determined in Step 112 that the “0” and “8” keys have been depressed, this is indicative of updating the signal formatting data in the memory for the audio receiver. Although not required, in the preferred embodiment the user will press the SELECT key 46 after the two digit designation of the electronic device whose signal formatting data is to be updated to provide an indication to the device that the user has completed the digit key entry.

After a determination is made in Step 112 as to which electronic device will have updated signal formatting data associated therewith (that is, “0,” “1” and SELECT for a cable set top box; “0,” “2” and SELECT, or “0,” “3” and SELECT for a television; “0,” “4” and SELECT for a VCR; “0,” “5” and SELECT or “0,” “6” and SELECT for a DVD player; “0,” “7” and SELECT for a CD player; or “0,” “8” and SELECT for an audio receiver), the method monitors the keypad for a new key press (Step 114). That is, the method is now ready to update the memory location corresponding to the signal formatting data of the electronic device designated by the user. The memory stores the subsequent keyed in entries (for example, using digit keys 36) as signal formatting data for the selected device.

Returning now to Step 114, the method monitors the keypad 30 for a new valid key press. A valid key press corresponds to any of the digit keys (0-9), the Arrow Left key, and Arrow Right key, the Arrow Down key, and the Arrow Up key. If a new valid key press is not made (NO in Step 114), then a determination is made in Step 116 as to whether a predetermined period of time has elapsed (for example, 10 seconds) since the last key press. If a valid new key press has not occurred within the predetermined period of time (YES in Step 116), then a determination is made that a valid key press has not been made and the upgrade programming mode is exited (Step 104) and the method returns to normal operation (Step 106). If the predetermined period of time has not elapsed (NO in Step 116), then the method returns to Step 114 to monitor for new key presses.

When a valid new key press is determined in Step 114, that is, either a digit key (0-9), Arrow Left, Arrow Right, Arrow Down, or Arrow Up key is pressed, a determination is made in Steps 118, 120, 122, 124 and 126 as to which valid key press has been made.

In order to update the signal formatting data for a specific electronic device, the user must execute a particular sequence of key presses using the digit keys which is preferably provided by the manufacturer of the remote control unit. It is foreseen that the manufacturer of the electronic device or a third party could also provide this information to the user, as long as the information is specific to the remote control unit and the electronic device. In the preferred embodiment three groups of signal formatting data information are entered via the keypad to the remote control unit. A first group corresponds to the signal protocol of the control signal to which the specific electronic device is responsive. A second group corresponds to key data information, for example, the type of signal which should be transmitted to the electronic device for each key on the remote control unit. A third group corresponds to additional protocol information, for example, whether to transmit the signal twice to the electronic device, etc. While three groups of signal formatting data are described, it is foreseen that more or less groups could be employed.

In the preferred embodiment the Arrow Left key, Arrow, Right key and Arrow Down key are indicative of portions of the signal formatting data where the newly input key press information should be stored. In the preferred embodiment the Arrow Left key sets the flag for writing 8 bit data to the section of the memory corresponding to the first group of signal formatting data, the Arrow Right key sets the flag for writing 16 bit data to the section of the memory corresponding to the second group of signal formatting data, and the Arrow Down key sets the flag for writing key data information to the section of the memory corresponding to the third group of signal formatting data.

Returning now to Step 114, once a valid key press is determined, Steps 118, 120, 122, 124 and 126 monitor for depression of a digit key or arrow key. In the preferred embodiment the user will first enter an Arrow Left key (Step 120) to set the flag in the memory for writing the first group of signal formatting data (8 bit data) to the corresponding section of the memory (Step 128). The method then returns to Step 114 wherein the sequence of key presses provided by the manufacturer of the remote control unit or the manufacturer of the electronic device are input by the user. In the preferred embodiment, after every two key presses the SELECT key is depressed to indicate that the just entered data is to be stored in the memory of the remote control unit. In this way, if the user depresses an incorrect key and the SELECT key has not been actuated, the user can re-enter the correct sequence of key entries which will overwrite or erase the prior (incorrect) key entries.

Once the user has depressed the correct sequence of digit keys and the SELECT key is depressed (YES in Step 118), the data is stored in the area of memory designated in Step 128 (Step 130). The method then returns to Step 114 to identify new valid key presses by the user. Once all of the 8 bit data corresponding to the first set of signal formatting data information is entered by the user and stored in the designated section of memory (Steps 114, 118, 130), the user then presses the Arrow Right key. If it is determined that the Arrow Right key is pressed (YES in Step 122), the flag is set in the memory for writing the second group of signal formatting data (16 bit data) to the corresponding section of memory (Step 132). The method returns to Step 114 to monitor for new key presses. Thereafter the user inputs via the keypad the second group of signal formatting data information provided by the manufacturer of the remote control unit or the manufacturer of the electronic device. In Step 118 the method checks for the entry of digit keys and then the SELECT key. If the digit keys and SELECT key are pressed, as explained above in connection with the entry of the first set of signal formatting data information (YES in Step 118), the data is stored in the memory address location designated in Step 132 (Step 130) and the signal formatting data information is continually input by the user and stored in the corresponding section of the memory (Steps 114, 118 and 130) until all of the signal formatting data information for the second group has been entered.

After the 16 bit data of the second group of signal formatting data information is entered, the method returns to Step 114 wherein the user will preferably press the Arrow Down key, which is indicative of the user wanting to enter the third set of signal formatting data information for storage in memory. If the Arrow Down key is pressed (YES in Step 124), the flag is set in the memory for writing key data information to the designated section of the memory (Step 134). The method then returns to Step 114 wherein the user enters the key data information by pressing the digit keys provided by the manufacturer of the remote control unit or the manufacturer of the electronic device and then the SELECT key. After each two key presses, the user preferably presses the SELECT key (YES in Step 118) and the corresponding data is stored in the area of memory designated in Step 134.

After the user has entered all of the key presses corresponding to the third group of signal formatting data information, the user will press the Arrow Up key (YES in Step 126) which changes the current device mode and instructs the remote control unit to utilize the new upgraded code when generating signals to transmit commands to the particular device identified in Step 112. The remote control device then provides a visual indication to the user that the update process is complete by flashing LEDs of the remote control unit for a predetermined period of time (Step 136) to indicate that the update process is complete. The method then exits the upgrade programming mode (Step 138) and the device returns to normal operation (Step 106).

For each electronic device which does not respond to the control codes generated by the signal formatting data stored in the remote control unit, the user can repeat the above process to enter new signal formatting data to remotely control the specific electronic device.

In the event that after the new signal formatting data is entered by the user certain key presses of the remote control unit do not properly control the corresponding electronic device, the user can re-enter the upgrade programming mode and re-enter the first, second and third groups of signal formatting data information, or any one of the first, second and third groups of signal formatting data information by selecting the specific group to be updated. That is, if the user determines that an error in digit key entry occurred while entering the first group of signal formatting data information, the user can re-enter that information (without having to enter the second and third groups of information) by pressing the Arrow Left key (Step 120) and entering the appropriate data in Step 114 to have the data stored in Step 130. If the user confirms that only the first group of signal formatting data needed to be corrected, the user could then exit the programming mode by pressing the Arrow Up key (Step 126).

By segmenting the signal formatting data information into three groups, in the event that an error occurs during input of the signal formatting data, the user can select the specific group of data which the user believes is incorrect, as opposed to inputting all three groups of the signal formatting data.

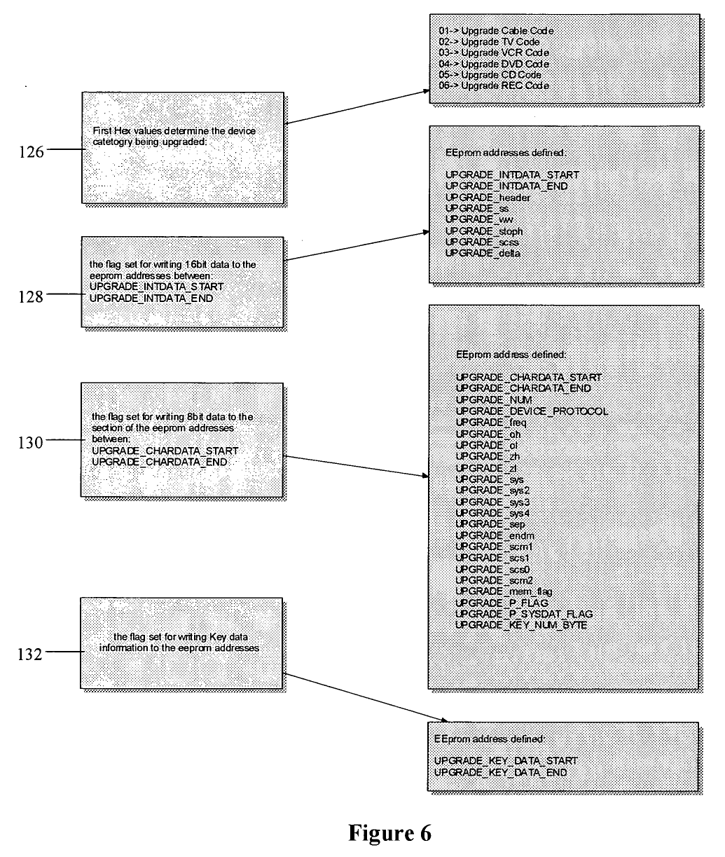

Referring now to FIG. 6, a chart is shown which indicates the actions taken by the remote control unit with respect to its memory after the input of the device type, the first portion of the signal formatting data, the second portion of the signal formatting data and the third portion of the signal formatting data.

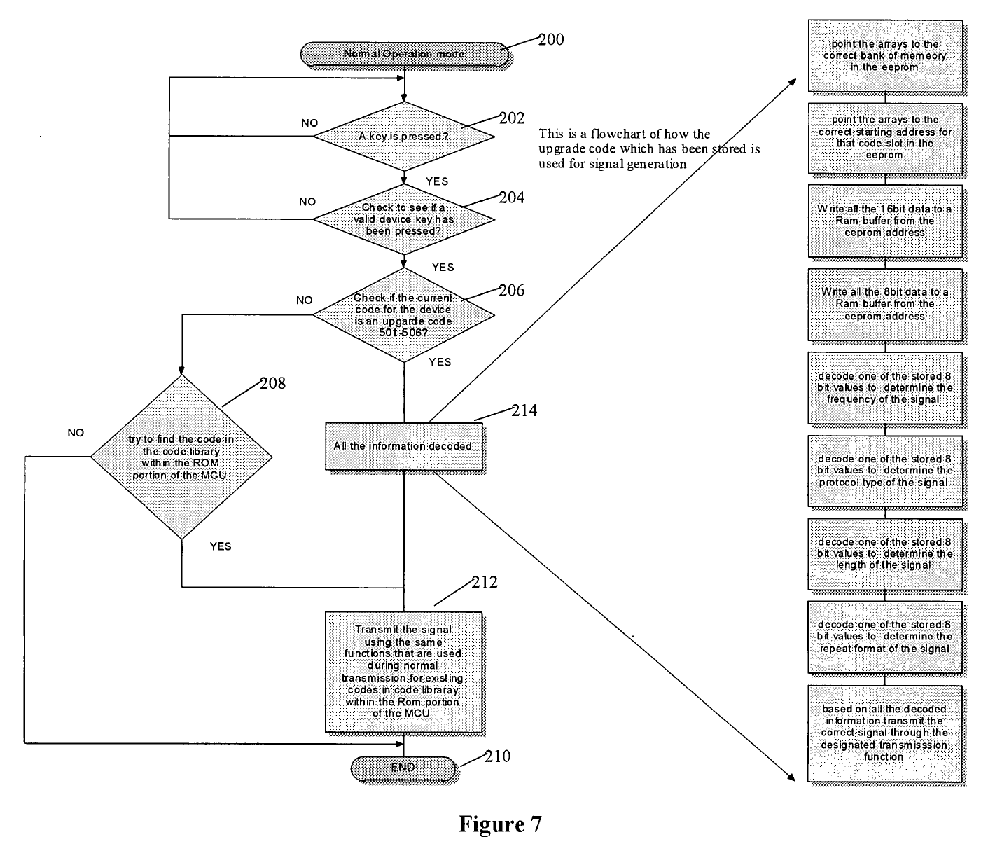

Referring now to FIG. 7, a method of using the updated signal formatting data stored in the memory of the remote control unit to control an electronic device is shown.

Step 200 is indicative of the normal operation mode wherein the remote control unit continually monitors for a key press (Step 202). After a key press has been recognized (YES in Step 202), a determination is made as to whether the key pressed is a valid key for the device being controlled (Step 204). If the key pressed is not a valid key for the device being controlled (for example, pressing the video functions 38 in the TV mode) (NO in Step 204), the method returns to monitor for a next key press (Step 202).

Once a valid key for the device being controlled has been pressed (YES in Step 204), a determination is made as to whether the current code for the device being controlled is an update code (Step 206). If the current code for the device being controlled is not an update code (NO in Step 206), the remote control unit determines which previously stored signal formatting data has been indicated as controlling the particular device (Step 208) and the remote control unit locates the corresponding signal formatting data in the code library to generate the appropriate control signal (YES in Step 208). If a specific pre-stored signal formatting data has not been indicated as controlling the electronic device and cannot be identified by the remote control unit (NO in Step 208), the electronic device cannot be controlled and the method ends (Step 210).

If the signal formatting data which controls the electronic device is found in the code library of the memory (YES in Step 208), the processor generates a control signal in accordance with the signal formatting data and transmits the control signal via the transmitter (Step 212).

Returning to Step 206, if the current code for the device is an update code (YES in Step 206), the signal formatting data which is stored in the memory in association with the update code for the particular device is decoded (Step 214), and an appropriate control signal is generated and transmitted via the processor and transmitter to control the electronic device (Step 212).

It may occur during execution of the update programming mode that the user incorrectly enters information via the keypad. As previously indicated, to correct entered values before the SELECT key is depressed, the user can re-enter the two correct values and then press the SELECT key. This serves to overwrite or erase the previously incorrectly entered data with the newly entered data. However, to correct either the device type being updated or the first, second or third portions of the signal formatting data after an arrow key has been depressed, the user can re-enter the key presses and press the corresponding Arrow key (41, 43, 44, 45) to store the information at the appropriate location of memory for that electronic device. If the user determines that there were incorrect key presses after the entire update has been performed, the user can return to the programming mode and enter the code corresponding to the specific device signal formatting data which is to be corrected. Since the signal formatting data is divided into three portions, the user will identify which portion of the data was incorrectly entered (either the first portion corresponding to protocol information, the second portion corresponding to key data information, or the third portion corresponding to additional protocol information). The user will re-enter either the first portion, second portion or third portion of the signal formatting data and depress the corresponding arrow key such that the just input data will be stored at the appropriate location in the memory.

An advantage of the update programming method is that once the user has completed the process of updating the memory with additional signal formatting data, the signal formatting data is stored until the user changes the signal formatting data for that particular device. Therefore, if updated signal formatting data is stored in the remote control unit and the user is desirous of utilizing the remote control unit to control an electronic device which can be controlled by one of the pre-stored codes in the remote control unit, the user can switch between the newly added code and the pre-stored code as desired.

Another advantage is that the remote control unit can be directly updated by a user without the necessity of a technician being dispatched to the user or additional expensive components such as a receiver, serial or USB port, or slot for acceptance of additional memory.

Thus, while various embodiments of the present invention have been illustrated and described, it will be appreciated by those skilled in the art that changes and modifications may be made thereunto without departing from the spirit and scope of the invention. For example, while it has been described that the mode pushbuttons 50 will illuminate to indicate that the update programming mode has been entered, it is envisioned that other suitable indicators such as audio, visual or tactile indicators could also be utilized.

What is claimed:

1. A method of updating a memory of a universal remote control unit which includes a keypad having keys, the method comprising the steps of:
initiating, by a user, an updating mode;
entering, by a user, a code associated with a device type to be controlled by the remote control unit;
entering, by a user, a signal formatting data entry which includes signal formatting data, via the keys of the keypad, to be stored in the memory of the remote control unit; and
associating the device type to be controlled by the remote control unit with the signal formatting data entry.

2. The method as defined by claim 1, wherein the step of initiating comprises the user entering, via the keys of the keypad, a code which initiates the updating mode.

3. The method as defined by claim 1, wherein the step of entering, by a user, a code associated with a device type to be controlled by the remote control unit, comprises entering the code via the keys of the keypad.

4. The method as defined by claim 1, wherein when one or more of a device type key associated with the device type is subsequently depressed, subsequent commands sent by the remote control unit have a format specified by the signal formatting data.

5. The method as defined by claim 1, wherein when a command key uniquely associated with the device type is depressed, commands sent by the remote control unit have the format specified by the signal formatting data.

6. The method as defined by claim 1, wherein the signal formatting data includes first, second and third portions stored at respective locations in the memory.

7. A universal remote control unit for remotely controlling a plurality of devices, comprising:
a memory having a plurality of locations for storing signal formatting entries at respective locations in the memory which are permanently written therein, and a location for storing a signal formatting entry which can be rewritten;
a keypad having a plurality of keys for entering, by a user, a first sequence of keypad strokes for actuating an upgrade mode and entering, by a user, a second sequence of keypad strokes indicative of new signal formatting data not previously stored in the memory;
a transmitter;
a processor, which when an upgrade mode is actuated by the user entering the first sequence of keypad strokes, enabling the user to enter the second sequence of keypad strokes indicative of the new signal formatting data not previously stored in the memory, and storing the new signal formatting data in one of the plurality of memory locations for storing signal formatting data not previously stored in the memory.

8. The universal remote control unit as defined by claim 7, wherein the keypad is utilized for entering, by a user, a third sequence of keypad strokes indicative of a device type associated with the new signal formatting data.

9. The universal remote control unit as defined by claim 7, wherein the processor accesses the new signal formatting data from the memory to control the transmitter to transmit a control signal in conformance with the new signal formatting data in response to actuation of the keypad.

10. The universal remote control unit as defined by claim 7, wherein the new signal formatting data includes first, second and third portions.

11. The universal remote control unit as defined by claim 7, wherein the memory includes a plurality of locations for storing a plurality of signal formatting entries.

12. An article of manufacture comprising:
a computer usable medium having computer readable program code means embodied therein for updating a memory of a universal remote control unit which includes a keypad having keys, the computer readable program code means in said article of manufacture comprising:
a computer usable medium having computer readable program code means embodied therein for initiating, by a user, an updating mode;
a computer usable medium having computer readable program code means embodied therein for entering, by a user, a code associated with a device type to be controlled by the remote control unit;
a computer usable medium having computer readable program code means embodied therein for entering, by a user, a signal formatting data entry which includes signal formatting data, via the keys of the keypad, to be stored in the memory of the remote control unit; and 1
a computer usable medium having computer readable program code means embodied therein for associating the device type to be controlled by the remote control unit with the signal formatting data entry.
